(19) United States
(12) Patent Application Publication
(10) Pub. No.: US 2008/0313287 A1
(43) Pub. Date: Dec. 18, 2008

(54) E-MAIL PUBLISHING OF PHOTOS TO PHOTO ALBUMS

(75) Inventors: Jason R. Wadsworth, Tokyo (JP); Keizo Fujiwara, Tokyo (JP); Robert William Ketcherside, Tokyo (JP); Michael A. Smuga, Seattle, WA (US); Jason Andrew Antonelli, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/763,485

(22) Filed: Jun. 15, 2007

(51) Int. Cl. G06F 15/16; G06F 3/00

(52) U.S. Cl. 709/206; 715/700

(57) ABSTRACT

Aspects of the subject matter described herein relate to publishing content via e-mail. In aspects, a user configures a publishing component to enable photos to be published to an album via e-mail. The user may indicate valid e-mail addresses from which e-mails may be sent to publish to the album. A keyword is associated with the album. The keyword is used to generate an e-mail address associated with the album. This e-mail address is provided to the user. The user may then publish photos to the album by sending e-mails conveying photos to the e-mail address. The server hosting the album may verify that the e-mail came from a valid e-mail address.

### BACKGROUND

Digital cameras are ubiquitous. The resolution and quality of digital cameras have increased while the price has gone down. The size of digital cameras has also decreased such that many cell phones are now equipped with a digital camera. A person with such a cell phone can take a picture and store it on the cell phone. Because of the limited memory on a cell phone, only a certain number of pictures can be stored on the cell phone. Transferring the picture to a computer for more long term storage and for sharing with others has not been very convenient.

### SUMMARY

Briefly, aspects of the subject matter described herein relate to publishing content via e-mail. In aspects, a user configures a publishing component to enable photos to be published to an album via e-mail. The user may indicate valid e-mail addresses from which e-mails may be sent to publish to the album. A keyword is associated with the album. The keyword is used to generate an e-mail address associated with the album. This e-mail address is provided to the user. The user may then publish photos to the album by sending e-mails conveying photos to the e-mail address. The server hosting the album may verify that the e-mail came from a valid e-mail address.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary mobile device into which aspects of the subject matter described herein may be incorporated;

FIG. 2 is a block diagram representing an exemplary environment in which aspects of the subject matter described herein may be implemented;

FIG. 3 illustrates elements of an exemplary web page that may be used to configure e-mail publishing in accordance with aspects of the subject matter described herein;

FIG. 4 is a block diagram that represents an exemplary server configured to operate in accordance with aspects of the subject matter described herein;

FIG. 5 is a flow diagram that generally represents exemplary actions that may occur in a quick setup publishing to an album in accordance with aspects of the subject matter described herein;

FIG. 6 is a flow diagram that generally represents actions that may occur when a user wants to publish photos to an existing album that is not currently associated with a keyword in accordance with aspects of the subject matter described herein;

FIG. 7 is a block diagram that generally represents exemplary actions that may occur when publishing photos to an album from a server and intermediate transmitting device perspectives according to aspects of the subject matter described herein; and

FIG. 8 is a block diagram that generally represents exemplary actions that may occur when publishing photos to an album from a sending device perspective according to aspects of the subject matter described herein.

### DETAILED DESCRIPTION

### Exemplary Operating Environment

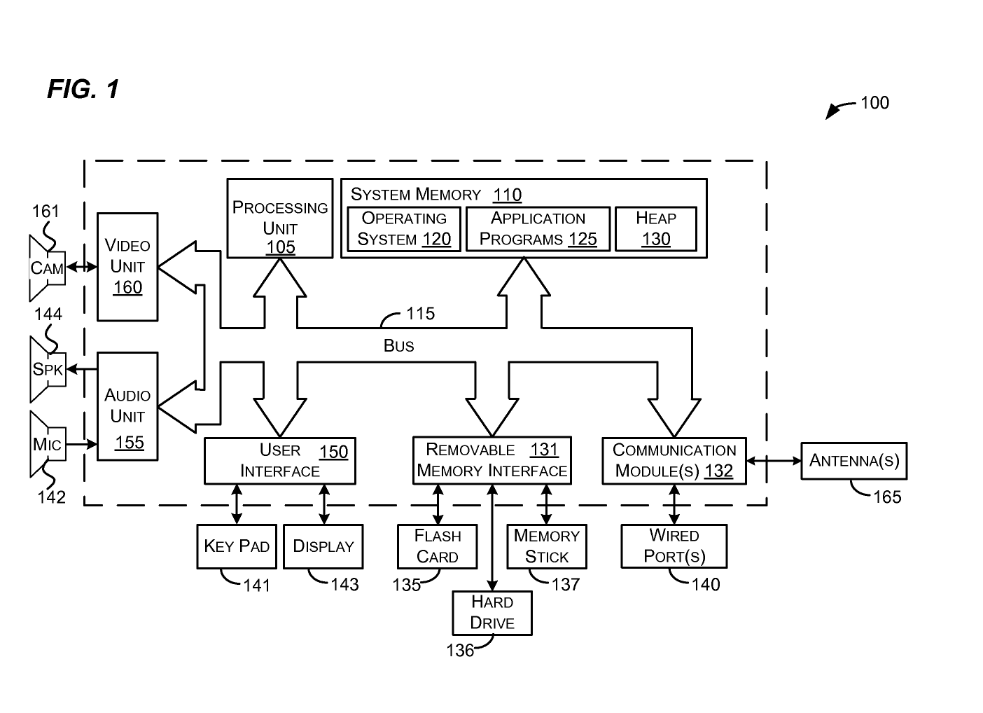

FIG. 1 illustrates an example of a suitable mobile device 100 on which aspects of the subject matter described herein may be implemented. The mobile device 100 is only one example of a device and is not intended to suggest any limitation as to the scope of use or functionality of aspects of the subject matter described herein. Neither should the mobile device 100 be interpreted as having any dependency or requirement relating to any one or combination of components illustrated in the exemplary mobile device 100.

With reference to FIG. 1, an exemplary device for implementing aspects of the subject matter described herein includes a mobile device 100 in the form of a cell phone. Components of the mobile device 100 may include, but are not limited to, a processing unit 105, system memory 110, and a bus 115 that couples various system components including the system memory 110 to the processing unit 105. The bus 115 may include any of several types of bus structures including a memory bus, memory controller, a peripheral bus, and a local bus using any of a variety of bus architectures, and the like. The bus 115 allows data to be transmitted between various components of the mobile device 100.

The mobile device 100 may include a variety of computer-readable media. Computer-readable media can be any available media that can be accessed by the mobile device 100 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 100.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 110 includes computer storage media in the form of volatile and/or nonvolatile memory and may include read only memory (ROM) and random access memory (RAM). On a mobile device, operating system code 120 is sometimes included in ROM although, in other embodiments, this is not required. Similarly, application programs 125 are often placed in RAM although again, in other embodiments, application programs may be placed in ROM or in other computer-readable memory. The heap 130 provides memory for state associated with the operating system 120 and the application programs 125. For example, the operating system 120 and application programs 125 may store variables and data structures in the heap 130 during their operations.

The mobile device 100 may also include other removable/non-removable, volatile/nonvolatile memory. By way of example, FIG. 1 illustrates a flash card 135, a hard disk drive 136, and a memory stick 137. The hard disk drive 136 may be miniaturized to fit in a memory slot, for example. The mobile device 100 may interface with these types of non-volatile removable memory via a removable memory interface 131, or may be connected via a universal serial bus (USB), IEEE 1394, one or more of the wired port(s) 140, or antenna(s) 165. In these embodiments, the removable memory devices 135-137 may interface with the mobile device via the communications module(s) 132. In some embodiments, not all of these types of memory may be included on a single mobile device. In other embodiments, one or more of these and other types of removable memory may be included on a single mobile device.

In some embodiments, the hard disk drive 136 may be connected in such a way as to be more permanently attached to the mobile device 100. For example, the hard disk drive 136 may be connected to an interface such as parallel advanced technology attachment (PATA), serial advanced technology attachment (SATA) or otherwise, which may be connected to the bus 115. In such embodiments, removing the hard drive may involve removing a cover of the mobile device 100 and removing screws or other fasteners that connect the hard drive 136 to support brackets within the mobile device 100.

The removable memory devices 135-137 and their associated computer storage media, discussed above and illustrated in FIG. 1, provide storage of computer-readable instructions, program modules, data structures, and other data for the mobile device 100. For example, the removable memory device 135-137 may store images taken by the mobile device 100, contact information, programs, data for the programs and so forth.

A user may enter commands and information into the mobile device 100 through input devices such as a key pad 141 and the microphone 142. In some embodiments, the display 143 may be touch-sensitive screen and may allow a user to enter commands and information thereon. The key pad 141 and display 143 may be connected to the processing unit 105 through a user input interface 150 that is coupled to the bus 115, but may also be connected by other interface and bus structures, such as the communications module(s) 132 and wired port(s) 140.

A user may communicate with other users via speaking into the microphone 144 and via text messages that are entered on the key pad 141 or a touch sensitive display 143, for example. The audio unit 155 may provide electrical signals to drive the speaker 144 as well as receive and digitize audio signals received from the microphone 142.

The mobile device may include a video unit 160 that provides signals to drive a camera 161. The video unit 160 may also receive images obtained by the camera 161 and provide these images to the processing unit 105 and/or memory included on the mobile device 100. The images obtained by the camera 161 may comprise video, one or more images that do not form a video, or some combination thereof.

The communication module(s) 132 may provide signals to and receive signals from one or more antenna(s) 165. One of the antenna(s) 165 may transmit and receive messages for a cell phone network. Another antenna may transmit and receive Bluetooth® messages. Yet another antenna may transmit and receive network messages via a wireless Ethernet network standard.

In some embodiments, a single antenna may be used to transmit and/or receive messages for more than one type of network. For example, a single antenna may transmit and receive both voice and packet messages.

When operated in a networked environment, the mobile device 100 may connect to one or more remote devices. The remote devices may be a personal computer, a server, a router, a network PC, a cell phone, a peer device or other common network node, and typically includes many or all of the elements described above relative to the mobile device 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

### E-mail Publishing

As mentioned previously, transferring images from a mobile device to another device has not been very convenient. Often, doing this transfer may involve connecting the mobile device to the other device through a wired link or transferring computer-readable media (e.g., a memory device) between the mobile device and the other device.

Although aspects of the subject matter described herein are described in conjunction with photos, in other embodiments, other data may be shared by mechanisms described herein. In one embodiment, any content including text, hyperlinks, multi-media content, a file or set of files, any other data structure or structures, and the like may be transferred from a mobile device via the mechanisms and techniques described herein. Thus, while in some embodiments, the content that may be transferred via aspects of the subject matter described herein comprises photo images and albums placed on a server, in other embodiments, aspects described herein apply to files or other data structures placed on a server. Furthermore, unless explicitly indicated otherwise, in some embodiments, the terms “photo” and “album” as well as when used as part of a word (e.g., albumID, photos, albums) may be replaced with “content” wherever they are found in the detailed description. In other embodiments, the terms “photo” and “album” have the definition described in the next paragraph.

As used herein, in some embodiment, an album is a collection of one or more images. The images do not need to be taken by a camera and may scanned or created images. As used herein, in some embodiments, a photo includes an image that may be stored on a computer-readable medium and also does not need to be taken by a camera.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like that is capable or receiving photos and/or albums.

In some embodiments, the mobile device referred to herein comprises a cell phone, a handheld device that allows voice communications with others, or some other voice communications device. In these embodiments, the mobile device is most often equipped with a camera for taking pictures, although this may not be required in other embodiments. In other embodiments, aspects of the subject matter described herein may also be applied to other mobile devices including PDAs, notebook computers, printers, appliances, other mobile devices, and the like. In yet other embodiments, aspects of the subject matter described herein may be applied to devices that are generally considered non-mobile such as personal computers, servers, and the like.

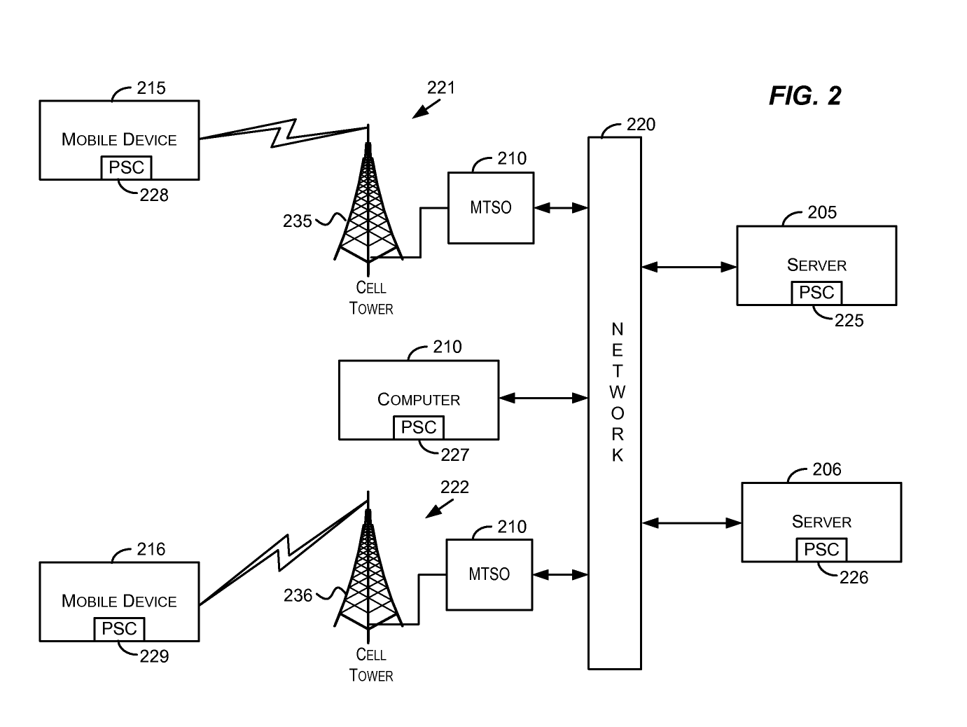

FIG. 2 is a block diagram representing an exemplary environment in which aspects of the subject matter described herein may be implemented. The environment includes servers 205-206, computer 210, and mobile devices 215-216 (hereinafter sometimes collectively referred to as the entities) and may include other components (not shown). The entities may communicate with each other via various networks including intra- and inter-office networks, telephone lines, the network 220, cell phone networks 221 and 222, other wireless and wired networks, and the like. In one embodiment, the network 215 may comprise the Internet.

The cell phone networks 221 and 222 may include mobile telephone switching offices (MTSO) 231 and 231 respectively, for example located within the cells generated by the cell towers 235 and 236, respectively. In other embodiments, the MTSOs may be located elsewhere. Each MTSO is a central switch that controls the operation of a cellular sub-system. In one embodiment, the MTSO may be implemented as a sophisticated computer system that monitors cellular calls, tracks the location of cellular devices (e.g. cellular-equipped vehicles, hand-carried mobile phones or cellular-equipped PDA devices, etc.) stationary or traveling in the system, arranges handoffs (e.g., between cells within the system), keeps track of billing information, and the like. Each MTSO may additionally function as a conduit to allow communications to and from the mobile devices 215 and 216 to others of the entities.

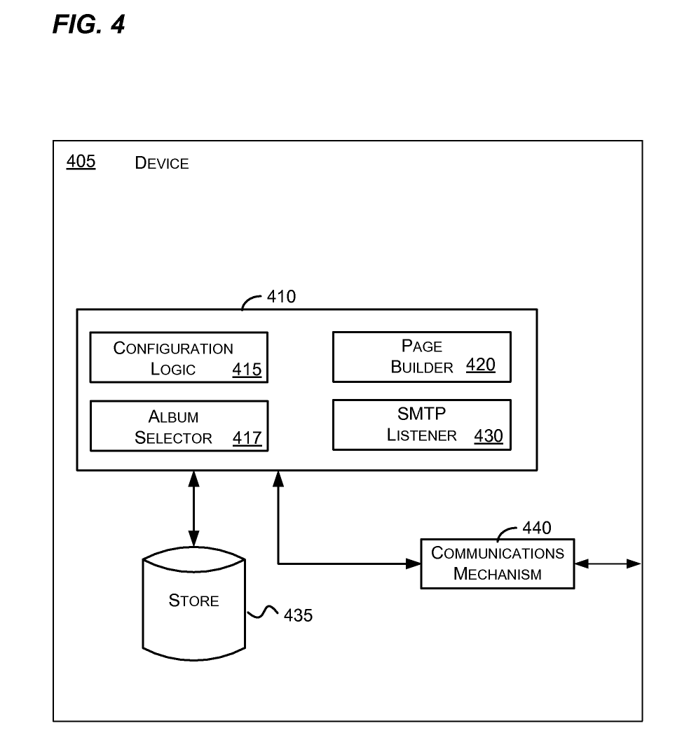

The servers 205-206, computer 210, and the mobile devices 215-216 may include publishing system components 226-229, respectively. Publishing system components are described in more detail below with respect to FIG. 4. Briefly, the publishing system components allow for photos and albums to be transferred from the mobile devices 215-216 and the computer 210 to the servers 205-206. The publishing system components may also publish such transferred photos for access by others. On the sending side, the publishing system components may comprise a web browser, client software, other software, and the like capable of configuring server publishing components and sending e-mail to the server publishing components.

Each of the servers 205-206 and the computer 210 may be implemented on one or more computers and there is no intention to limit the types of computers to those thought particularly as server computers or client computers. Indeed a computer that serves as a home computer may at times serve as a server computer and vice versa.

In one embodiment, the servers 205-206 may replicate photos for scalability and redundancy, for example. In another embodiment, the servers 205-206 may each host a certain subset of photos. Users of the mobile devices 215-216 and the computer 210 may have accounts hosted on one or more of the servers 205-206.

In one embodiment, the mobile devices 215-216 may be implemented as described in conjunction with the mobile device 100 of FIG. 1. In one embodiment, the mobile devices 215-216 may comprise cell phones.

Although the environment described above includes various numbers of each of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

In an embodiment, to transfer photos from a mobile device or computer to a server for publishing, a user may set up one or more e-mail addresses. Each time the user sends e-mail to one of the e-mail addresses, a server component (e.g., an SMTP listener) may examine the e-mail and obtain any attached or embedded photos contained therein. Based on the e-mail address, the server may determine in which albums to publish the photos. In one embodiment, the server may use the subject line of the e-mail to provide a caption for the sent photos.

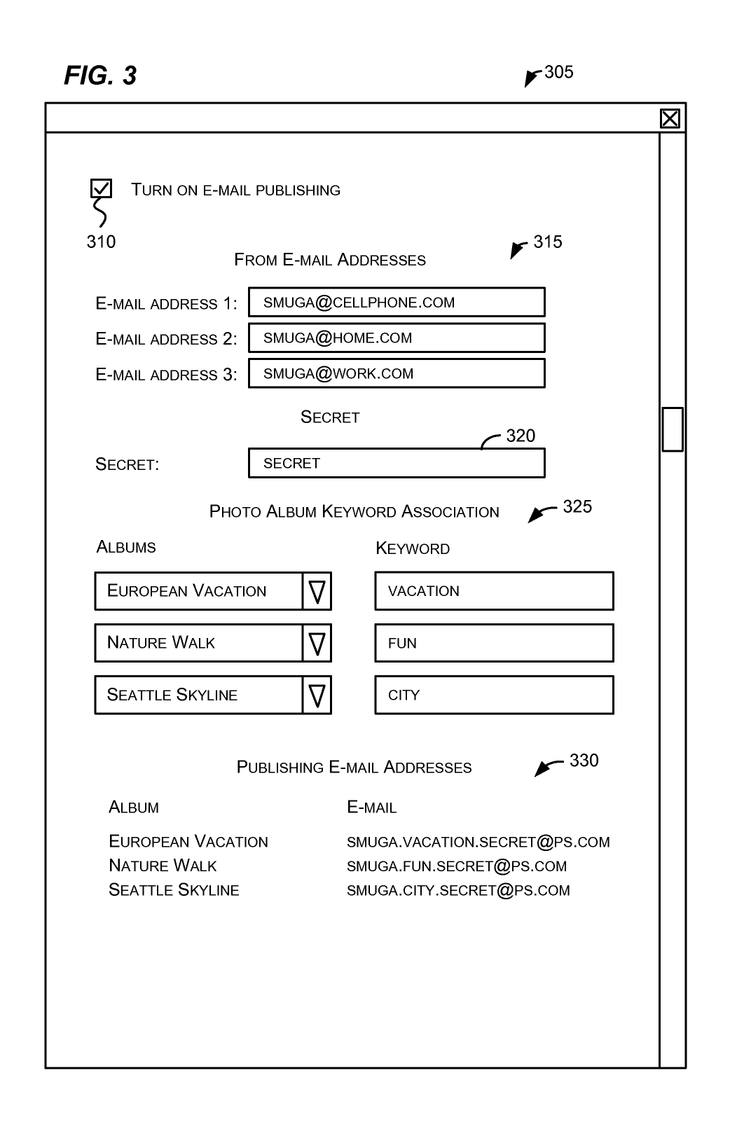

For example, a server may include server publishing software that allows a user to access the user's account via a web page. FIG. 3 illustrates elements of an exemplary web page that may be used to configure e-mail publishing in accordance with aspects of the subject matter described herein. Using the web page 305, a user may enable or disable e-mail publishing via a check box 310. The user may also enter e-mail addresses from which the user is able to publish text or photos. The user may enter these e-mail addresses in text boxes shown in the area 315. When the server obtains an e-mail that includes text or photos to publish, the server may check to determine whether the e-mail was sent from one of the e-mail addresses. If not, the server may discard the e-mail and any photos or text.

Through the web page 305, the user may also enter a secret word in a text box 320. The secret word may be used in creating a unique e-mail address to which the user can send content as will be described in more detail below. The secret word may be used to authenticate/authorize a user to the publishing component. As the secret word may be any arbitrary sequence of characters and can be kept secret and made difficult to guess, the secret word can further enhance the security of the system.

The web page 305 may also provide a mechanism for associating albums the user has on the server with keywords as shown in area 325. The keywords may also be used in creating the e-mail to which the user can send e-mails to publish photos as described in more detail below.

The web page 305 may indicate e-mail addresses to which photos need to be sent to publish to particular albums in area 330. For example, a user may be able to publish to an album “European vacation” with an e-mail address such as: smuga.vacation.secret@ps.com. The portion “smuga” of the e-mail address may correspond to a username by which the user is known on the server. The “secret” portion of this e-mail address corresponds to the secret previously entered by the user in the text box 320. The “vacation” portion of the e-mail may correspond to an identifier that the user has associated with a European Vacation album in the area 325. The “ps” portion may be a domain name that identifies one or more servers that host the photo albums for the user smuga.

The web page 305 as shown include three e-mail addresses and 3 albums/keyword associations. In other embodiments, however, they may be more or fewer of these elements. Furthermore, the ordering and/or spatial arrangement of the elements and areas may be changed in other embodiments. The web page 305 may also include additional text to inform a user about the configuration choices and their effect.

It will be recognized by those skilled in the art that the information obtained via the web page 305 may be performed via many variations of input screens without departing from the spirit or scope of aspects of the subject matter described herein. Furthermore, although in one embodiment, a web page may be used to configure the publishing system, in other embodiments this may be done via one or more application pages without using a web browser. In response to user input, the application may communicate with a server to notify the server of the data included in the one or more application pages.

To simplify sending photos to the server even more, a user on a cell phone may enter each of the e-mail addresses in separate contacts on the cell phone. Then, to send photos to the server to be published in a particular album, the user may simply send an e-mail to the appropriate contact. The process above may also be employed for a personal computer or other computing device.

FIG. 4 is a block diagram that represents an exemplary server configured to operate in accordance with aspects of the subject matter described herein. The device 405 may include a publishing component 410, a store 435, and a communications mechanism 440. The publishing component 410 may include configuration logic 415, an album selector 417, page builder 420, and a SMTP listener 430. The device 405 may correspond to one of the servers 205-206 of FIG. 2. The publishing component 410 corresponds to the publishing system components 225-226 of FIG. 2.

The communications mechanism 440 allows the device 405 to receive configuration information and e-mails from other devices as well as receive requests for the albums. The communications mechanism 440 may be a network interface or adapter, modem, or any other mechanism for establishing communications, for example.

The store 435 is any storage media capable of storing content including albums and images. The store 435 may also store publishing configuration information for each user that has an account hosted on the device 405. The store 435 may comprise a file system, database, volatile memory such as RAM, other storage, some combination of the above, and the like and may be distributed across multiple devices. The store 435 may be external or internal to the device 405.

In operation, the device 405 may receive a web page request to provide a page to configure e-mail publishing for an account from a device (such as one of the devices 227-229 of FIG. 2). This request may be handled at least in part by the configuration logic 415 which may access the store 435 to obtain any previous settings and to save updated settings as appropriate. The configuration logic 415 may be instrumental in processing input from the user regarding the items identified in FIG. 3 and may also construct the e-mail addresses to which the user may send e-mail's to publish photos to the device 405.

The SMTP (simple mail transport) listener 430 may monitor incoming e-mail's. E-mails that are determined to be from any of the e-mail addresses indicated in area 315 of FIG. 3 may be passed to the album selector 417 for publishing. The album selector 417 may determine the album into which a photo is to be placed based on the e-mail address of the photo and the associations previously made in the web page 305 of FIG. 3. An e-mail may embed one or more photos within the e-mail and/or may include the one or more photos as attachments.

The SMTP listener 430 may also have the capability of determining if a message includes text that needs to be published. The SMTP listener 430 may make this determination based on the e-mail address to which the e-mail is addressed. For example, a user may publish text to a web log (blog) by sending an e-mail to a particular e-mail address. This e-mail address may be entered via the web page 300 or via another input screen. The ability to receive and publish text may be in addition to the ability to receive photos to publish.

Code (e.g., HTML) for displaying the albums (or thumbnails, icons, links, or other references thereto) may be created by the page builder 420. The page builder may also create code for other text, links, multi-media material, and the like and cause the photos to be displayed at various places on a displayed page.

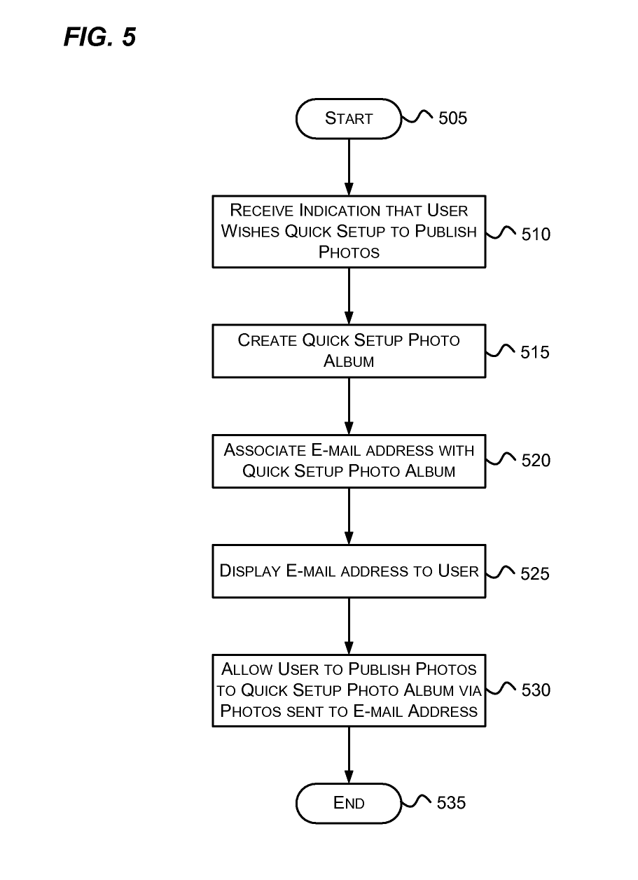

FIGS. 5-8 are flow diagrams that generally represent exemplary actions that may occur in accordance with aspects of the subject matter described herein. For simplicity of explanation, the methods described in conjunction with FIGS. 5-7 are depicted and described as a series of acts. It is to be understood and appreciated that the aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methods in accordance with aspects of the subject matter described herein. In addition, those skilled in the art will understand and appreciate that the methods could alternatively be represented as a series of interrelated states via a state diagram or as events.

FIG. 5 is a flow diagram that generally represents exemplary actions that may occur in a quick setup publishing to an album in accordance with aspects of the subject matter described herein. The actions described in conjunction with FIG. 5 may be performed when a user wants to publish to a photo album but does not want to go through a complicated setup to do so. At block 505, the actions begin.

At block 510, an indication is received that a user wishes to a quick setup to publish photos. For example, on a cell phone, a user may select a hyperlink, a checkbox, or some other user interface element that indicates that the user wants to quickly setup publishing to an album.

At block 515, a photo album is created for the quick setup. For example, referring to FIG. 4, the configuration logic 415 creates an album and gives it a name (e.g., mphotos).

At block 520, an e-mail address is associated with the album. For example, referring to FIG. 4, the publishing component 410 may associate an e-mail address of smuga.mphotos.secret@ps.com with the album.

At block 525, the e-mail address and/or a link thereto may be sent to and displayed to the user. For example, referring to FIGS. 2 and 4, the device 405 may send the e-mail address in a web page to the mobile device 100 for display. The mobile device 100 may display the web page including the e-mail address so that the user may view the e-mail address and add it to the user's contacts on the mobile device 100.

At block 530, the user is allowed to publish photos to the album via the e-mail address. For example, referring to FIG. 4, the SMTP listener 430 may look for e-mails from the e-mail address. When such an e-mail is received, the SMTP listener 430 may forward it to the album selector 417 which may place the photos conveyed with the e-mail into the album which is stored on the store 435.

At block 535, the actions end.

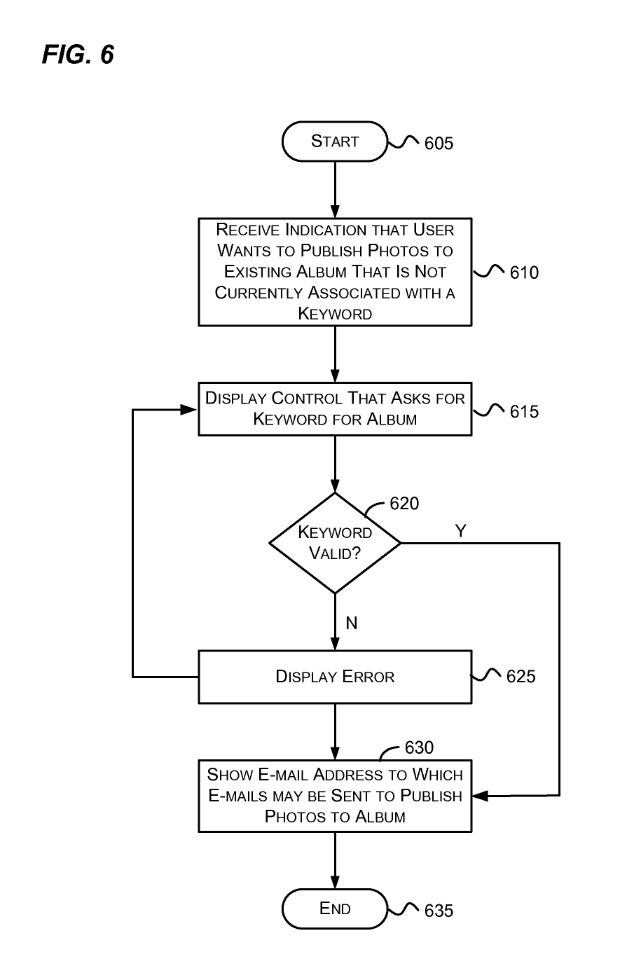

FIG. 6 is a flow diagram that generally represents actions that may occur when a user wants to publish photos to an existing album that is not currently associated with a keyword in accordance with aspects of the subject matter described herein. For example, the user may have a photo album set up but may not have associated it with a keyword yet. To do so, the actions described below may occur.

At block 605, the actions begin. At block 610, an indication is received that indicates that the user wants to publish photos to an existing album that is not currently associated with a keyword. For example, the user may select an album and may have an option of indicating that the user wants to publish photos to this album via e-mail.

At block, 615 a control is displayed that asks the user for a keyword to associate with the album. The control may be a page, dialog box, a text box, or some other control, for example. The control may display a system-generated keyword (e.g., an identifier unique to the system) and may allow the user to change this system-generated keyword.

At block 620, a determination is made as to whether the keyword is valid. If so, the actions continue at block 630; otherwise, the actions continue at block 625. A keyword may not be valid, for example, if it is too long, too short, contains characters outside a certain set of characters, is not unique to identify the album, and so forth.

At block 625, an error is displayed that the keyword is not valid. Processing then continue at block 615 to prompt for a new keyword.

At block 630, an e-mail address is generated to which e-mails may be sent to publish photos to the album. This e-mail address is then shown to the user. The user may enter this e-mail address into a contact so that the user may easily send new photos to publish to the album.

At block 635, the actions end.

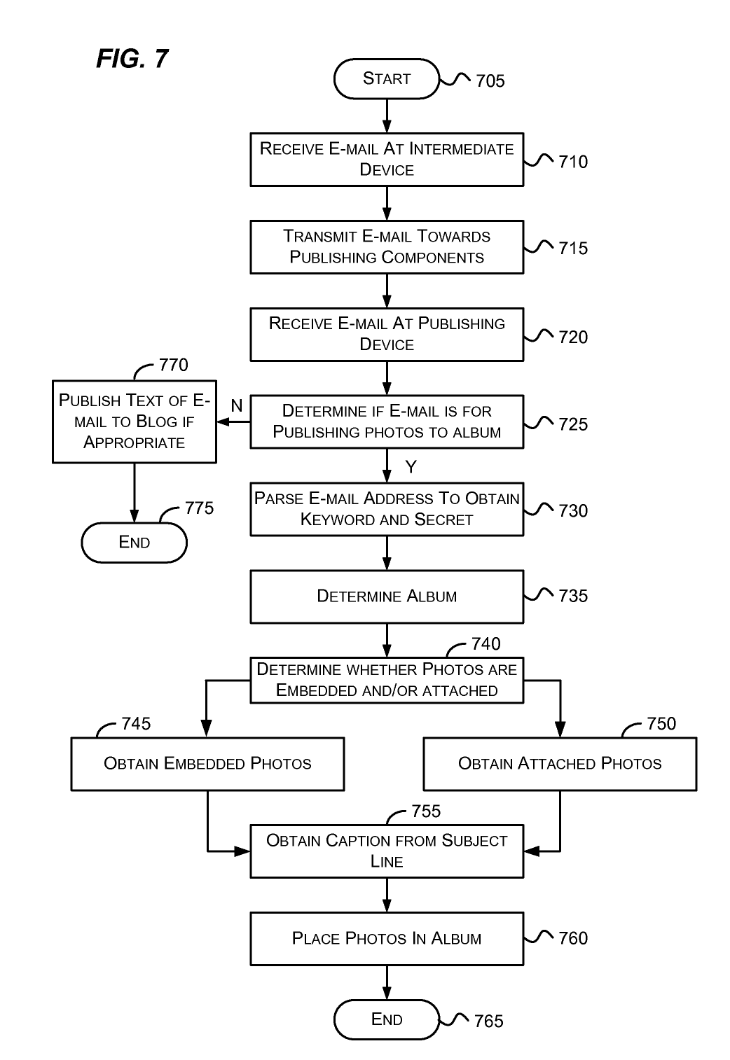

FIG. 7 is a block diagram that generally represents exemplary actions that may occur when publishing photos to an album from a server and intermediate transmitting device perspectives according to aspects of the subject matter described herein. At block 705, the actions begin.

At block 710, the e-mail may be received at a device intermediate to the publishing components. For example, the e-mail may be received by a switch, router, modem, network appliance, network adaptor, or some other device between the sending device and the publishing components. The device referred to above may be external to or may actually be a component of the device upon which the publishing components reside. For example, the e-mail may be received at a network adapter of the device 405 of FIG. 4. As another example, the e-mail may be received at the cell tower 235, or the MTSO 210 of FIG. 2.

At block 715, the e-mail is transmitted towards the publishing components. If the e-mail is received at a device external to the device 405, it is transmitted towards the device 405. If the e-mail is received at a device (e.g., a network adapter) on the device 405, it is transmitted towards the publishing components 410 of the device 405.

At block 720, the e-mail is received at the device that hosts the album. For example, referring to FIG. 2, the server 205 may receive an e-mail from the mobile device 215.

At block 725, a determination is made as to whether the e-mail is for publishing photos to an album on the device. If not, the actions continue at block 770; otherwise, the actions continue at block 730. For example, the e-mail may not include a keyword, a secret word, and/or may not include a username of a valid user. If this is the case, the e-mail may be passed by with respect to publishing photos.

At block 730, the target e-mail address of the e-mail is parsed to obtain the keyword corresponding to an album as well as the secret. For example, a keyword of “vacation” and the secret “secret” may be obtained from an e-mail addressed to smuga.vacation.secret@ps.com. The secret may be used to authenticate/authorize the user to the publishing component as indicated previously.

At block 735, the album identifier associated with the keyword is obtained. For example, referring to FIG. 3, the album identifier of “European Vacation” may be obtained. If the album identifier is not valid or does not identify an existing album, an e-mail may be sent to the user of the mobile device indicating the error.

At block 740, a determination is made as to whether photos are embedded and/or attached to the e-mail. While in most cases, it is likely that photos are either attached (e.g., as attachments) or embedded (e.g., in the body of the e-mail), in some embodiments, one or more photos may be embedded in an e-mail while one or more other photos are attached to the e-mail.

At blocks 745, the embedded photos are obtained from the e-mail. At block 750, the attached photos are obtained from the e-mail. For example, referring to FIG. 4, the system publishing components 410 may obtain the one or more photos from an e-mail. Note that the actions associated with both of the blocks 745 and 750 may be performed for any particular e-mail as one or more photos may be embedded while one or more other photos may be attached to a single e-mail.

At block 755, a caption may be obtained from the subject line of the e-mail. This caption may be used as previously to caption the photos attached with the e-mail when placing the photos in the album.

At block 760, the photo(s) are placed in the album. For example, referring to FIG. 4, the publishing system components 410 may store the photo(s) in an album in the store 435.

At block 770, text in the e-mail is published to a blog if appropriate. For example, a publishing component may be configured to publish to a blog if the e-mail address does not contain an album identifier, such that the email address is composed solely of [username].[secret]@[ps].com. In this case, the publishing component may publish to the user's blog if the e-mail address meets requirements for identification and security.

At blocks 765 and 775, the actions end.

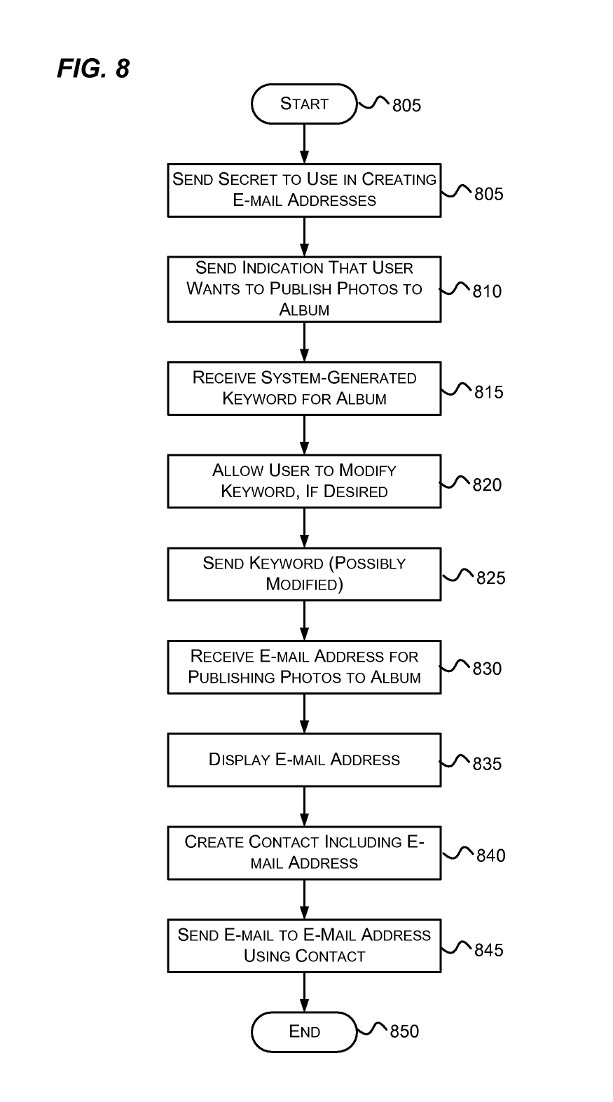

FIG. 8 is a block diagram that generally represents exemplary actions that may occur when publishing photos to an album from a sending device perspective according to aspects of the subject matter described herein. At block 705, the actions begin.

At block 805, a secret is sent to use in creating e-mail addresses. For example, referring to FIG. 3, a user may enter a secret in the text box 320. This secret may then be sent to a server for use in e-mail publishing.

At block 810, an indication is sent that a user wants to publish photos via e-mail to an album. For example, a user may select an album and be presented with an option to enable photo publishing via e-mail to the album. If the user selects the option, this indication may be sent to a server.

At block 815, a system-generated keyword for the album is received. For example, referring to FIG. 2, the server 205 may generate a keyword for the album. Alternatively, the mobile device or the computer seeking to configure e-mail publishing for an album may generate a keyword to associate with the album.

At block 820, the user is allowed to modify the keyword, if desired. For example, a text box may be displayed to the user allowing the user to modify the keyword.

At block 825, the keyword (possibly modified) is sent to the server to associate the album with the keyword. For example, referring to FIG. 2, the mobile device 215 may send a keyword of “vacation” to the server 205 to associate the “European Vacation” album with the keyword “vacation.”

At block 830, an e-mail address is received for publishing photos to the album. As described previously, in one embodiment, the e-mail address may be generated, in part, from a username, secret, and keyword.

At block 835, the e-mail address is displayed. For example, referring to FIG. 1, the e-mail address may be displayed on the display 143.

At block 840, a contact including the e-mail address may be created. For example, the user may enter the e-mail address into a contact so that the user may easily publish photos by sending e-mails via the contact.

At block 845, an e-mail is sent to the e-mail address using the contact. For example, the user may indicate that an e-mail is to be sent, select the contact, and attach or embed photos in the e-mail. Note that the actions associated with block 805-840 do not need to be repeated unless the user changes the settings. To send a photo to an album any time after the actions associated with blocks 805-840, the user simply needs to perform the actions associated with block 845.

At block 850, the actions end.

The mechanism described herein may also be applied to content publishing systems that publish content other than photos and albums. For example, the mechanisms described herein may be applied to publishing content to folders, message boards, and the like. It will be recognized by those skilled in the art that many other content publishing systems may incorporate aspects of the subject matter described. As such, there is no intention to limit the spirit or scope of aspects of the subject matter described herein to albums and photos or to particular types of publishing systems.

As can be seen from the foregoing detailed description, aspects have been described related to publishing content via e-mail. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
receiving an e-mail having a destination e-mail address, the e-mail address including a keyword associated with an album, the e-mail conveying a photo, the keyword indicating an album to which the photo is to be added; and
transmitting the e-mail towards a component responsible for publishing photos to the album.

2. The computer-readable medium of claim 1, further comprising:
parsing the e-mail address to obtain the keyword;
determining the album based on an association between the keyword and the album;
obtaining the photo conveyed with the e-mail; and
placing the photo in the album.

3. The computer-readable medium of claim 2, further comprising determining that the photo is embedded in the e-mail and obtaining the photo from within the e-mail.

4. The computer-readable medium of claim 2, further comprising determining that the photo is conveyed as an attachment to the e-mail and obtaining the photo from the attachment.

5. The computer-readable medium of claim 2, further comprising obtaining a caption to be published with the photo from a subject line of the e-mail.

6. The computer-readable medium of claim 1, further comprising providing a configuration screen capable of associating albums with keywords.

7. The computer-readable medium of claim 6, wherein the configuration screen includes one or more input fields for receiving a set of one or more source e-mail addresses, wherein the set of one or more source e-mail addresses indicate that photos are only to be placed in the album if they come from one of the set of one or more source e-mail addresses.

8. The computer-readable medium of claim 6, wherein the configuration screen indicates albums and e-mail addresses associated with the albums, each indicated album having a different e-mail address associated therewith.

9. The computer-readable medium of claim 2, further comprising in response to an activation of a user interface element, creating the album, creating the e-mail address, and providing the e-mail address.

10. The computer-readable medium of claim 9, wherein the user interface element comprises a hyperlink to setting up publishing of photos to the album.

11. A method implemented at least in part by a computer, the method comprising:
sending a keyword to be associated with an album, the album capable of including one or more photos, the album stored on a device that is accessible via a network;
receiving an e-mail address to which an e-mail may be sent to publish a photo to the album, the e-mail conveying with it at least one photo to publish a photo to the album; and
displaying the e-mail address.

12. The method of claim 11, further comprising sending an indication that indicates that a user wants to publish photos to the album, the album existing before receiving the indication.

13. The method of claim 11, further comprising sending a secret, the secret to be used in creating the e-mail address.

14. The method of claim 11, further comprising creating a contact associated with the e-mail address, wherein selecting the contact shows a user interface element that allows a user to send an e-mail to the e-mail address.

15. The method of claim 11, further comprising receiving the keyword and allowing the user to change the keyword before sending the keyword to be associated with the album.

16. In a computer system, a graphical user interface, comprising:
a first area for receiving an indication of one or more source e-mail addresses from a user, the source e-mail addresses indicating a set of valid e-mail addresses from which an e-mail is to be sent to be published;
a second area for associating keywords with albums, each album being associated with a different keyword; and
a third area for displaying associations between albums and e-mail addresses, each album being associated with one e-mail address.

17. The graphical user interface of claim 16, further comprising an area for receiving a secret, the secret being used to create the e-mail addresses.

18. The graphical user interface of claim 16, wherein the graphical user interface is displayed on a display of a cell phone.

19. The graphical user interface of claim 16, wherein the graphical user interface is displayed on a display of a computer.

20. The graphical user interface of claim 16, wherein the graphical user interface is displayed via a web page.
